(19) United States
(12) Patent Application Publication
(10) Pub. No.: US 2023/0169716 A1
(43) Pub. Date: Jun. 1, 2023

(54) TEXTURING METHOD OF GENERATING 3D VIRTUAL MODEL AND COMPUTING DEVICE THEREFOR

(71) Applicant: 3I INC., Daegu (KR)

(72) Inventors: Ken KIM, Seoul (KR); Ji Wuck JUNG, Goyang-si (KR); Farkhod Rustam Ugli KHUDAYBERGANOV, Seoul (KR); Mikhail LI, Paju-si (KR)

(73) Assignee: 3I INC., Daegu (KR)

(21) Appl. No.: 17/878,390

(22) Filed: Aug. 1, 2022

Related U.S. Application Data
(63) Continuation of application No. PCT/KR2021/017707, filed on Nov. 29, 2021.

(51) Int. Cl. G06T 15/04; G06T 17/20

(52) U.S. Cl. CPC G06T 15/04; G06T 17/20; G06T 2200/08

(57) ABSTRACT

A texturing method of generating a three-dimensional (3D) virtual model is provided. The method is performed in a computing device, and includes acquiring an original learning image and a hole generation learning image for the original learning image, the hole generation learning image being an image in which at least one hole is generated based on the original learning image, generating a hole filling learning image by performing hole filling on the hole generation learning image using a neural network, performing spherical transformation on each of the hole filling learning image and the original learning image, and training the neural network based on a difference between the spherically transformed hole filling learning image and the spherically transformed original learning image.

### CROSS-REFERENCE TO RELATED APPLICATIONS

This application is a PCT Continuation By-Pass application of PCT Application No. PCT/KR2021/017707 filed on Nov. 29, 2021, in the Korean Intellectual Property Office, the entire disclosures of which are incorporated herein by reference for all purposes.

### BACKGROUND

### 1. Field

The following description relates to a texturing method of generating a three-dimensional (3D) virtual model for an indoor space and a computing device therefor.

### 2. Description of Related Art

In recent years, virtual space realization technologies have been developed to enable users to experience as if the users are in a real space without directly visiting the real space by being provided with an online virtual space corresponding to the real space.

Such real space-based virtual technology is a technology for implementing a digital twin or metaverse, and is being variously developed.

In order to implement such a virtual space, there is a need for a process of providing a virtual space by acquiring a flat image photographed for a real space to be implemented, and generating a three-dimensional virtual image, that is, a three-dimensional model, based on the acquired flat image.

The three-dimensional model is generated based on data photographed at several points in an indoor space. In this case, to construct the three-dimensional model, color and distance data obtained at 360° from several points in an indoor space are collected, and the three-dimensional model is generated based on the collected data.

In particular, since the respective points for generating a virtual space corresponding to such an indoor space are considerably spaced apart from each other, such as a distance of several meters, there is a limitation in that it is difficult to obtain good texturing quality for a 3D model based on such data.

### SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

One aspect provides a texturing method of generating a three-dimensional (3D) virtual model. The texturing method of generating a 3D virtual model that is performed in a computing device for generating a three-dimensional virtual model based on a plurality of data sets each generated at one of a plurality of photographing points in an indoor space, the data set including a color image, a depth image, and location information on each point, may include: generating a 3D mesh model based on the plurality of data sets each generated at one of the plurality of photographing points of the indoor space; selecting a first face from a plurality of faces included in the 3D mesh model, and selecting any one first color image suitable for the first face from a plurality of color images associated with the first face; performing texturing by selecting a local area corresponding to the first face from any one selected first color image and mapping the selected local area to the first face; and generating a first 3D model by performing a color image selection process and a texturing process on the remaining faces except for the first face among the plurality of faces included in the 3D mesh model.

Another aspect provides a computing device. The computing device may include: a memory configured to store one or more instructions; and at least one processor configured to execute the one or more instructions stored in the memory, in which the at least one processor may execute the one or more instructions to generate a 3D mesh model based on a plurality of data sets each generated at one of a plurality of photographing points in an indoor space, the data set including a color image, a depth image, and location information on each point, select a first face from a plurality of faces included in the 3D mesh model, and select any one first color image suitable for the first face from a plurality of color images associated with the first face, perform texturing by selecting a local area corresponding to the first face from any one selected first color image and mapping the selected local area to the first face, and generate a first 3D model by performing a color image selection process and a texturing process on the remaining faces except for the first face among the plurality of faces included in the 3D mesh model.

Still another aspect provides a storage medium. The storage medium is a storage medium in which computer-readable instructions are stored. When the instructions are executed by a computing device, the instructions may allow a computing device to execute the operation of: generating a 3D mesh model based on a plurality of data sets each generated at one of a plurality of photographing points in an indoor space, the data set including a color image, a depth image, and location information on each point, selecting a first face from a plurality of faces included in the 3D mesh model, and selecting any one first color image suitable for the first face from a plurality of color images associated with the first face, performing texturing by selecting a local area corresponding to the first face from any one selected first color image and mapping the selected local area to the first face, and generating a first 3D model by performing a color image selection process and a texturing process on the remaining faces except for the first face among the plurality of faces included in the 3D mesh mode.

Other features and aspects will be apparent from the following detailed description, the drawings, and the claims.

### BRIEF DESCRIPTION OF DRAWINGS

FIG. 1 illustrates a system that provides a texturing method of generating a three-dimensional (3D) virtual model, in accordance with one or more embodiments.

FIG. 2 is a block configuration diagram illustrating a computing device, in accordance with one or more embodiments.

FIG. 3 is a flowchart illustrating a texturing method of generating a 3D virtual model, in accordance with one or more embodiments.

FIG. 4, FIG. 5, FIG. 6, and FIG. 7 are diagrams illustrating an example of obtaining a color image, in accordance with one or more embodiments.

FIG. 8 is a flowchart illustrating a color image selection method of generating a 3D virtual model, in accordance with one or more embodiments.

FIG. 9, FIG. 10, FIG. 11, and FIG.12 are diagrams illustrating an example of selecting a color image, in accordance with one or more embodiments.

FIG. 13 is a flowchart illustrating an unseen face setting method of generating a 3D virtual model, in accordance with one or more embodiments.

FIG. 14 and FIG. 15 are views illustrating an example of setting an unseen face, in accordance with one or more embodiments.

FIG. 16 is a flowchart illustrating a color correction method of generating a 3D virtual model, in accordance with one or more embodiments.

FIG. 17 and FIG. 18 are diagrams illustrating an example of color correction, in accordance with one or more embodiments.

Throughout the drawings and the detailed description, the same reference numerals may refer to the same, or like, elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known, after an understanding of the disclosure of this application, may be omitted for increased clarity and conciseness, noting that omissions of features and their descriptions are also not intended to be admissions of their general knowledge.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween. Likewise, expressions, for example, “between” and “immediately between” and “adjacent to” and “immediately adjacent to” may also be construed as described in the foregoing.

The terminology used herein is for the purpose of describing particular examples only, and is not to be used to limit the disclosure. As used herein, the singular forms “a,” “an,” and “the” are intended to include the plural forms as well, unless the context clearly indicates otherwise. As used herein, the term “and/or” includes any one and any combination of any two or more of the associated listed items. As used herein, the terms “include,” “comprise,” and “have” specify the presence of stated features, numbers, operations, elements, components, and/or combinations thereof, but do not preclude the presence or addition of one or more other features, numbers, operations, elements, components, and/or combinations thereof. The use of the term “may” herein with respect to an example or embodiment (for example, as to what an example or embodiment may include or implement) means that at least one example or embodiment exists where such a feature is included or implemented, while all examples are not limited thereto.

Unless otherwise defined, all terms, including technical and scientific terms, used herein have the same meaning as commonly understood by one of ordinary skill in the art to which this disclosure pertains consistent with and after an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

The user terminal 500, computing device 300, processor 330, and other devices, and other components described herein are implemented as, and by, hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

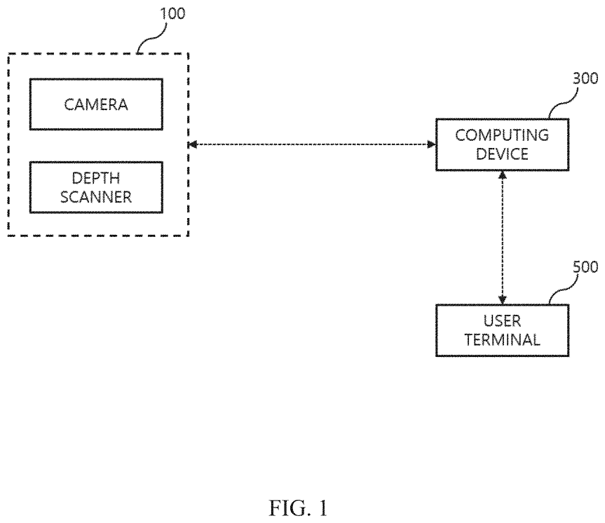

The methods that perform the operations described in this application, and illustrated in FIGS. 1-9, are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller, e.g., as respective operations of processor implemented methods. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that be performed by the hardware components and the methods as described above. In one example, the instructions or software include machine code that is directly executed by the one or more processors or computers, such as machine code produced by a compiler. In another example, the instructions or software include higher-level code that is executed by the one or more processors or computers using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), EEPROM, RAM, DRAM, SRAM, flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors and computers so that the one or more processors and computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

Although various flowcharts are disclosed to describe the embodiments of the present disclosure, this is for convenience of description of each step or operation, and each step is not necessarily performed according to the order of the flowchart. That is, each step in the flowchart may be performed simultaneously, performed in an order according to the flowchart, or may be performed in an order opposite to the order in the flowchart.

One or more examples are directed to effectively selecting an image suitable for a face of a three-dimensional (3D) model among a plurality of images generated at several points in a room.

One or more examples are directed to more accurately compensating color imbalance caused by different photographing conditions between several points in a room.

FIG. 1 is an exemplary diagram for describing a system that provides a texturing method of generating a three-dimensional (3D) virtual model according to an embodiment disclosed in the present disclosure.

The system for providing a texturing method of generating a 3D virtual model may include an image acquisition device 100, a computing device 300, and a user terminal 500.

The image acquisition device 100 is a device for generating a color image and/or a depth map image which are used to generate a spherical virtual image.

In the illustrated example, the image acquisition device 100 may include a distance measuring device, and a depth scanner and a camera in the illustrated example.

The camera is a device that provides a photographing function, and generates a color image expressed in color for a subject area (imaging area).

In the present disclosure, the color image encompasses all images expressed in color, and is not limited to a specific expression method. Accordingly, the color image may be applied to various standards such as red/green/blue (RGB) images expressed in RGB and cyan magenta yellow key (CMYK) images expressed in CMYK.

For example, the camera may include a mobile phone, a smart phone, a laptop computer, a personal digital assistant (PDA), a tablet PC, an ultrabook, a wearable device (for example, smart glasses), or the like.

A depth scanner is a device capable of generating a depth map image by generating depth information on a subject area.

In the present disclosure, the depth map image is an image including depth information on a subject space. For example, each pixel in a depth map image may be distance information from the imaging point to each point (point corresponding to each pixel) in a photographed subject space.

The depth scanner may include a predetermined sensor for measuring a distance, for example, a light wave detection and ranging (LiDAR) sensor, an infrared sensor, an ultrasonic sensor, and the like. Alternatively, the depth scanner may include a stereo camera, a stereoscopic camera, a 3D depth camera, etc., that may measure distance information by replacing a sensor.

The camera generates a color image, and the depth scanner generates a depth map. The color image generated by the camera and the depth map image generated by the depth scanner may be generated under the same conditions (e.g., resolution, etc.) for the same subject area, and match each other on a one-to-one basis.

The depth scanner and the camera may generate a 360° panoramic image form for an existing indoor space, that is, a 360° depth map panoramic image and a 360° color panoramic image, respectively, and may provide the generated 360° depth map panoramic image and 360° color panoramic image to the computing device 300.

The depth scanner may generate distance information on each of several points in a room on which such 360° photographing is performed. Such distance information may be relative distance information. For example, the depth scanner may have a plan view of an indoor space and receive an initial starting indoor point in the plan view according to a user input. Thereafter, the depth scanner may generate relative distance movement information based on image analysis and/or a movement detection sensor (for example, a 3-axis acceleration sensor and/or a gyro sensor, or the like). For example, information on a second indoor point may be generated based on the relative distance movement information from the starting indoor point, and information on a third indoor point may be generated based on relative distance movement information from a second indoor point. The generation of such distance information may be performed by a camera.

In one embodiment, the depth scanner and the camera may be implemented as one image acquisition device. For example, the image acquisition device 100 may be a smartphone that includes a camera for image acquisition and a LiDAR sensor for distance measurement.

The depth scanner or the camera may store information on a photographing height and provide the stored information to the computing device 300. The information on the photographing height may be used to generate a 3D model in the computing device 300.

The depth map image and the color image may be a 360° panoramic image, which is collectively referred to as the depth map image and the color image for convenience of description. The depth map image and the color image may be a panoramic image in a suitable form to provide a 360° image, for example, an equirectangular projection panoramic image.

The user terminal 500 is an electronic device through which a user may access the computing device 300 to experience a virtual 3D model corresponding to an indoor space, and may include, for example, a mobile phone, a smart phone, a laptop computer, a digital broadcasting terminal, a personal digital assistant (PDA), a portable multimedia player (PMP), navigation, a personal computer (PC), a tablet PC, an ultrabook, a wearable device (for example, a watch-type terminal (smartwatch), a glasses-type terminal (smart glasses), a head mounted display (HMD)), etc. However, in addition to this, the user terminal 500 may include electronic devices used for virtual reality (VR) and augmented reality (AR).

The computing device 300 may generate a 3D virtual model that is a 3D virtual space corresponding to an indoor space by using color images and depth map images each generated at one of several points in a room.

The computing device 300 may generate a 3D model based on the color images and the depth images generated from a plurality of photographing points in a room as a virtual space corresponding to a real space. The 3D model is a virtual model in which depth information is reflected, and may provide a 3D space equivalent to a real space.

The computing device 300 may generate a plurality of point sets (for example, a point cloud) in three dimensions based on the plurality of data sets (including a color image, a depth image, and location information on each point) generated at each of the plurality of photographing points in the indoor space, and generate a 3D mesh model based on these point sets. The 3D mesh model may be a mesh model created by setting a plurality of faces based on a plurality of vertices selected based on a point cloud. For example, one face may be generated based on three adjacent vertices, and each face may be a flat triangle with three vertices.

When each face is determined in the 3D mesh model, the computing device 300 may set color values of each face based on a color image associated with each face. The color image associated with the face may be set based on a direction vector perpendicular to a face.

The computing device 300 may select one color image to set the color values of each face. To this end, the computing device 300 may calculate a plurality of weighting factors for each color image, and then calculate weights based on the calculated weighting factors. The computing device 300 may select any one color image based on the weight.

The computing device 300 may perform color filling on an unseen face. The unseen face refers to a face that is not displayed in a captured image. For example, a plane higher than a photographing point (e.g., an upper surface of a refrigerator, etc.) is not photographed by a camera, and therefore, is set as the unseen face. The computing device 300 may fill the unseen face with a color based on the color information of the vertex.

The computing device 300 may perform color correction on a 3D model generated by completing the color filling for each face. In the present disclosure, even if the photographing is performed by the same camera, photographing conditions at several points in an indoor space are different. Even in the same indoor space, photographing conditions, such as a degree of brightness, an additional light source, and a color of the light source, at each point in an indoor space are different. For example, natural light from the sun is added at a photographing point in a room by a window, and illuminance is low at a photographing point in a room where lighting is turned off, so the photographing conditions of the camera may be changed. As described above, since the photographing conditions are different at several points in the indoor space, each color image has different color values even for the same subject. Accordingly, when one subject has a plurality of faces and each face is textured based on different color images, stains may occur in color expression of one subject. The computing device 300 may perform color correction to compensate for such stains. Such color correction may be performed by reflecting factors caused by differences between several photographing points in an indoor space.

As described above, the 3D model in the present disclosure has a special environment according to conditions for generating a virtual space corresponding to an indoor space. That is, it is required to acquire a color image and a depth image for an indoor space. To this end, the color image and the depth image are acquired from a plurality of photographing points in a room. Meanwhile, as the number of indoor points for acquiring an image increases, the amount of data for the 3D model increases. However, in embodiments of the present disclosure, it is possible to improve the representation of the 3D model, such as texturing, according to processing in the computing device 300. Accordingly, high-quality 3D models may be obtained even if the number of photographing points in a room for indoor image acquisition is set to an appropriate number.

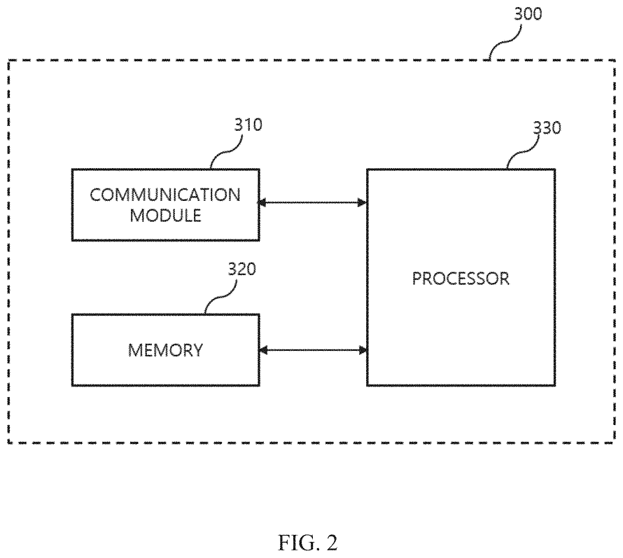

Hereinafter, the computing device 300 will be described in more detail with reference to FIGS. 2 to 15.

FIG. 2 is a block configuration diagram for describing the computing device according to the embodiment disclosed in the present disclosure.

As illustrated in FIG. 2, the computing device 300 according to the embodiment of the present disclosure may include a communication module 310, a memory 320, and a processor 330. However, such a configuration is an example, and it goes without saying that a new configuration may be added or some configurations may be omitted in addition to such a configuration in carrying out the present disclosure.

The communication module 310 includes a circuit and may communicate with an external device (including a server). Specifically, the processor 330 may receive various types of data or information from an external device connected through the communication module 310, and may transmit various types of data or information to the external device.

The communication module 310 may include at least one of a wireless fidelity (WiFi) module, a Bluetooth module, a wireless communication module, and may perform communications according to various communication standards such as a near field communication (NFC) module, Institute of Electrical and Electronics Engineers (IEEE), Zigbee, 3rd Generation (3G), 3rd Generation Partnership Project (3GPP), Long Term Evolution (LTE), and 5th Generation (5G).

At least one command related to the computing device 300 may be stored in the memory 320. The memory 320 may store an operating system (O/S) for driving the computing device 300. In addition, the memory 320 may store various software programs or applications for operating the computing device 300 according to various embodiments of the present disclosure. The memory 320 may include a semiconductor memory such as a flash memory, or a magnetic storage medium such as a hard disk, or the like.

Specifically, various software modules for operating the computing device 300 according to various embodiments of the present disclosure may be stored in the memory 320, and the processor 330 may execute various software modules stored in the memory 320 to control the operation of the computing device 300. That is, the memory 320 is accessed by the processor 330, and readout, recording, correction, deletion, update, and the like, of data in the memory 160 may be performed by the processor 330.

In addition, various pieces of information necessary within the scope for achieving the object of the present disclosure may be stored in the memory 320, and the information stored in the memory 320 may be updated as received from an external device or input by a user.

The processor 330 may be configured of one or more processors.

The processor 330 controls the overall operation of the computing device 300. Specifically, the processor 330 is connected to the configuration of the computing device 300 including the communication module 310 and the memory 320 as described above, and may control the overall operation of the computing device 300 by executing at least one command stored in the memory 320 as described above.

The processor 330 may be implemented in various schemes. For example, the processor 330 may be implemented by at least one of a processor, an application specific integrated circuit (ASIC), an embedded processor, a microprocessor, a hardware control logic, a hardware finite state machine (FSM), and a digital signal processor (DSP). Meanwhile, in the present disclosure, the processor 330 may be used in a sense including a central processing unit (CPU), a graphic processing unit (GPU), a main processing unit (MPU), and the like.

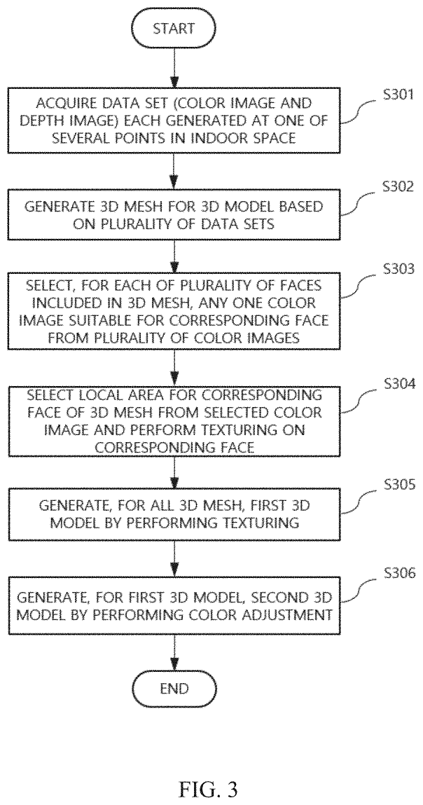

FIG. 3 is a flowchart illustrating a texturing method of generating a 3D virtual model according to an embodiment disclosed in the present disclosure.

Referring to FIG. 3, the computing device 300 receives a plurality of data sets each generated at one indoor point of a plurality of indoor spaces from the image acquisition device 100 (S301). Here, the data set includes a color image and a depth image photographed at the corresponding point, and location information on the corresponding indoor point.

The computing device 300 generates a 3D mesh model for generating a 3D model for an indoor space based on a plurality of data sets (S302).

The 3D mesh model may be generated by generating a plurality of point sets (e.g., a point cloud) generated based on color images and depth images for each indoor point, and arranging these generated point sets in a 3D space based on location information.

The computing device 300 may generate the 3D mesh model by selecting a plurality of vertices based on the point cloud and setting a plurality of faces based on the plurality of selected vertices. For example, the computing device 300 may set one triangular face based on three adjacent vertices.

Since a color value is not set for the face in the 3D mesh model, the computing device 300 repeatedly performs operations S303 to S304 to set a color value for each face, that is, to perform texturing.

The computing device 300 selects any one (first) face from a plurality of faces included in the 3D mesh model, and any one first color image suitable for the first face from a plurality of color images associated with the first face can be selected (S303).

Here, in selecting the color image associated with the first face, the computing device 300 may calculate a unit vector perpendicular to the first face, and select, as a color image associated with the corresponding face, at least one color image having a photographing angle corresponding to the unit vector based on calculated unit vector. This is because, when photographing the color image, the information on the photographing angle of the corresponding color image is generated together, and therefore, the color associated with the first face, that is, the color in which the first face is stamped, may be selected based on the photographing height and photographing angle information for the color image. For example, the computing device 300 selects, as a color image associated with the face, a color image having a unit vector perpendicular to the first face and a photographing angle opposite to the unit vector within a predetermined angle, that is, facing each other within a predetermined angle.

The computing device 300 may select any one color image suitable for the face from the color images associated with the face. For example, the computing device 300 may calculate a plurality of weighting factors for each associated color image, calculate a weight based on the calculated weighting factor, and select any one color image based on the weight.

For example, a first color image matching the first face may be selected from a plurality of color images associated with the 3D mesh model after evaluated based on a photographing direction, resolution, and color noise of the first face.

The computing device 300 may select a local area corresponding to the first face from one selected color image and map the selected local area to the first face, thereby performing texturing (S304).

Since the computing device 300 has information on the photographing location of each color image, each object in each color image and each object of the 3D mesh model may be projected and mapped to each other. Accordingly, based on the projection mapping between the 2D color image and the 3D mesh model, the local area in the 2D color image for the corresponding face may be selected.

The computing device 300 may perform texturing by generating color information for each face by repeatedly performing the above-described operations S303 to S304 on all faces of the 3D mesh model (S305). Since the 3D model thus generated is in a state in which color correction is not performed between the respective color images, stains may occur even on the same surface. This is because, as described above, the photographing environment at each photographing point in a room is different.

The computing device 300 may perform color adjustment in order to correct a color difference due to the photographing environment at each photographing point in a room (S306).

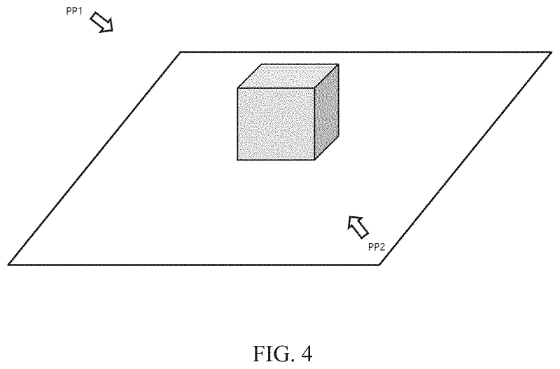

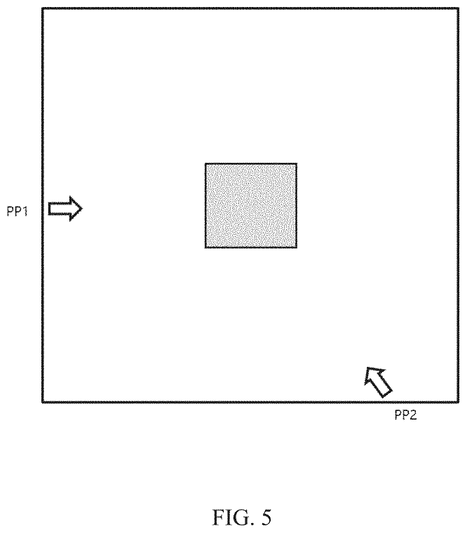

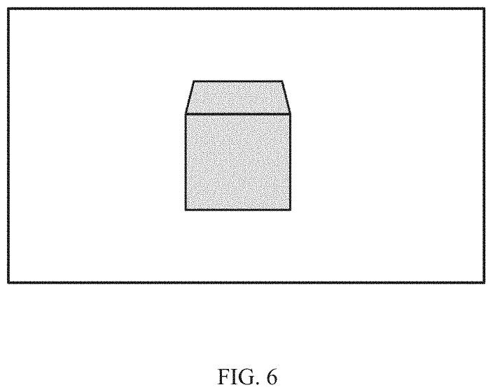

FIGS. 4 to 7 are diagrams for describing an example of obtaining a color image according to an embodiment disclosed in the present disclosure, and the present disclosure will be described with reference to the example.

FIG. 4 is a perspective view illustrating a cubic subject in an indoor space, and first and second photographing points PP1 and PP2 in a room for the cubic subject, as an example, and FIG. 5 is a plan view corresponding to FIG. 4. FIG. 6 illustrates an example of a color image photographed at the first photographing point PP1, and FIG. 7 illustrates an example of a color image photographed at the second photographing point PP2.

FIGS. 6 and 7 illustrate an example in which a color image is photographed for the same subject, but a color change due to shading occurs in FIG. 7.

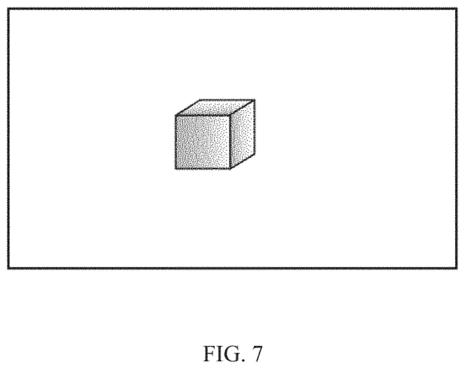

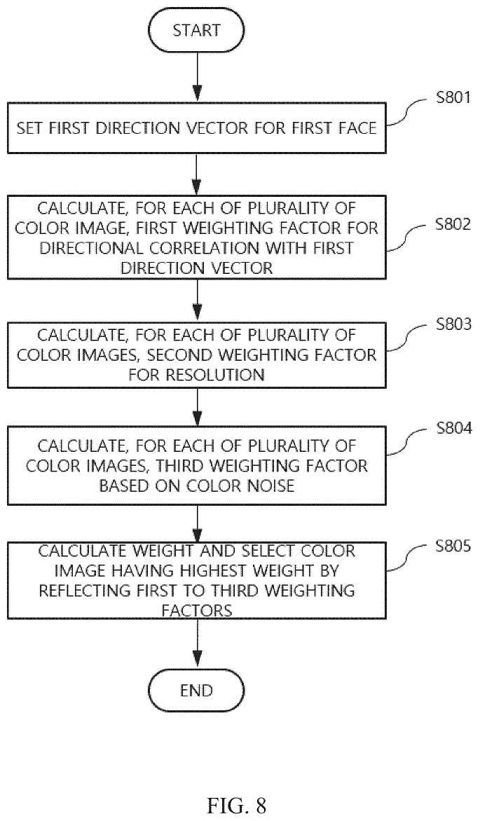

FIG. 8 is a flowchart illustrating a color image selection method of generating a 3D virtual model according to an embodiment disclosed in the present disclosure.

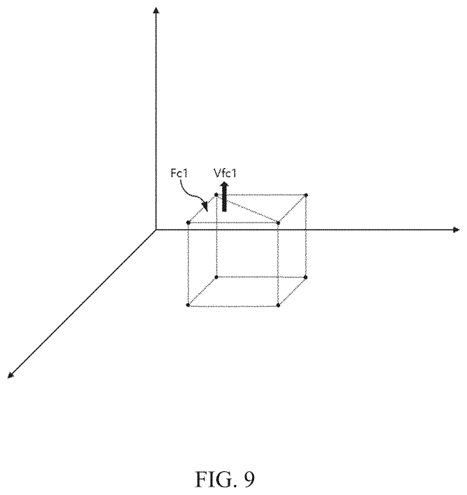

The flowchart illustrated in FIG. 8 is for a process of selecting a first color image to be mapped to the first face from a plurality of color images associated with the first face. FIGS. 9 to 12 are diagrams for describing an example of selecting a color image according to an embodiment disclosed in the present disclosure, and the present disclosure will be described with further reference to the example.

Referring to FIG. 8, the computing device 300 may set a reference vector for the first face of the 3D mesh model, that is, a first direction vector perpendicular to the first face (S801).

The computing device 300 may calculate, for the plurality of color images associated with the first face, first weighting factors each having a directional correlation with a first direction vector (S802).

The computing device 300 may check a photographing direction of a plurality of color images associated with the first face, and calculate the first weighting factor based on a directional correlation between the first direction vector of the first face and the photographing direction. For example, as the angle between the first direction vector of the first face and the photographing direction decreases, a higher weighting factor may be calculated.

The computing device 300 may calculate, for the plurality of color images associated with the first face, a second weighting factor for resolution (S803).

For example, the computing device 300 may check the resolution of the plurality of color images itself, and calculate the second weighting factor based on the resolution. That is, the higher the resolution, the higher the second weighting factor may be calculated.

As another example, the computing device 300 may identify an object to be textured or a face that is a part of the object, and calculate the second weighting factor based on the resolution of the identified object or face. Since the resolution of such an object or face is set in inverse proportion to the distance between the objects at the photographing point, a high second weight is given to a color image advantageous in terms of distance.

The computing device 300 may calculate, for the plurality of color images associated with the first face, a third weighting factor for noise (S804).

The computing device 300 may calculate color noise for each color image. In order to calculate the color noise, various methodologies such as unsupervised learning using a deep convolutional generative adversarial network (DCGAN) and a method using enlighten GAN may be applied.

The computing device 300 may allow a higher third weighting factor to be assigned as the color noise decreases.

The computing device 300 may calculate weights for each of the plurality of color images by reflecting the first to third weighting factors. The computing device 300 may select one color image having the highest weight as a first image mapped to the first face (S805).

Various algorithms are applicable to reflection of the first to third weighting factors. For example, the computing device 300 may calculate the weights in various ways, such as simply summing the first to third weighting factors or deriving an average thereof.

In the above-described example, it is exemplified that all of the first to third weighting factors are reflected, but the present disclosure is not limited thereto. Accordingly, it is possible to implement a modification such as calculating the weight based on the first weighting factor and the second weighting factor or calculating the weight based on the first weighting factor and the third weighting factor. However, even in this modification, including the first weighting factor is a factor providing higher performance.

FIG. 9 illustrates an example of setting a first direction vector perpendicular to a first face Fc1 among the cube. Referring to the examples illustrated in FIGS. 9 and 4, it can be seen that the first photographing point PP1 has a higher first weight than the second photographing point PP2.

FIG. 10 illustrates a local area P1Fc1 corresponding to the first face in the color image at the first photographing point PP1, and FIG. 11 illustrates a local area P2Fc1 corresponding to the first face in the color image at the second photographing point PP2.

Referring to FIGS. 10 and 11, it can be seen that the color image at the first photographing point PP1 illustrated in FIG. 10 has a higher resolution than the color image of FIG. 11, and therefore, the second weighting factor is higher.

Since the color noise will be set higher in the color image at the second photographing point PP2 illustrated in FIG. 11, the first photographing point PP1 illustrated in FIG. 10 will have a higher third weighting factor.

Accordingly, for the first face, the color image at the first photographing point PP1 will be selected, and FIG. 12 illustrates that texturing is performed on the first face by matching the local area P1Fc1 in the color image at the first photographing point PP1 to the first face.

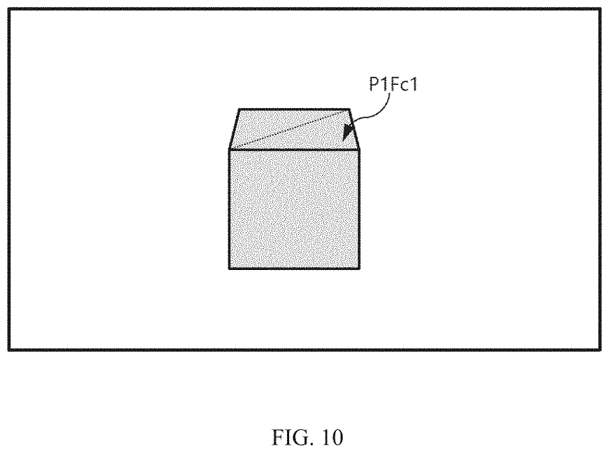

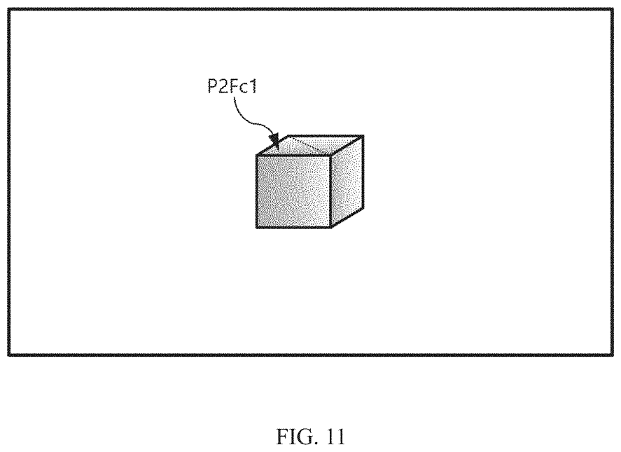

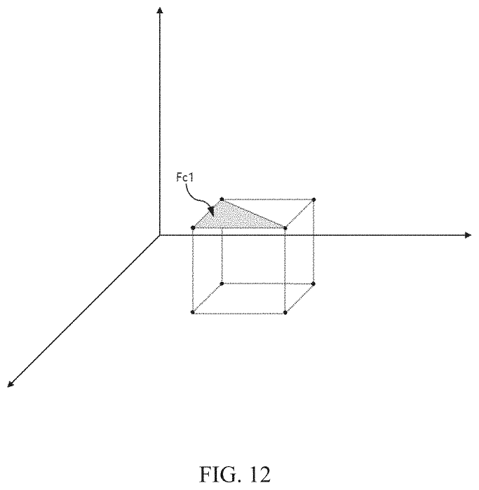

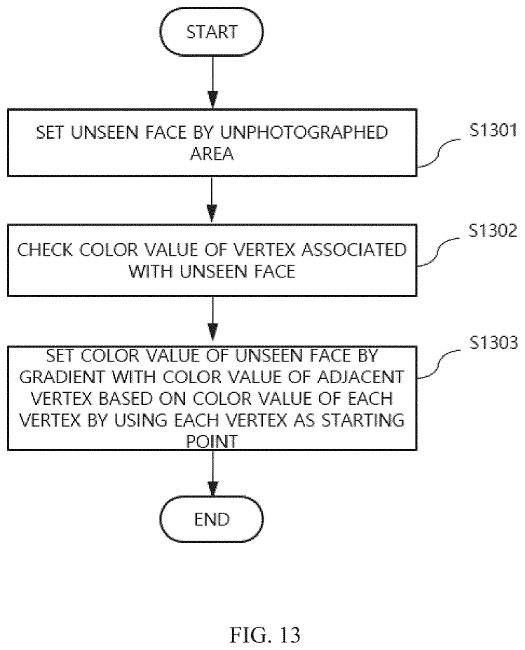

FIG. 13 is a flowchart for describing an unseen face setting method of generating a 3D virtual model according to an embodiment disclosed in the present disclosure.

The color image mapping and texturing are performed on each face through the above-described process, but in the case of some faces, an image to be mapped may not be selected. Such a face is commonly referred to as an unseen face, which occurs in a portion that may not be photographed due to a photographing angle.

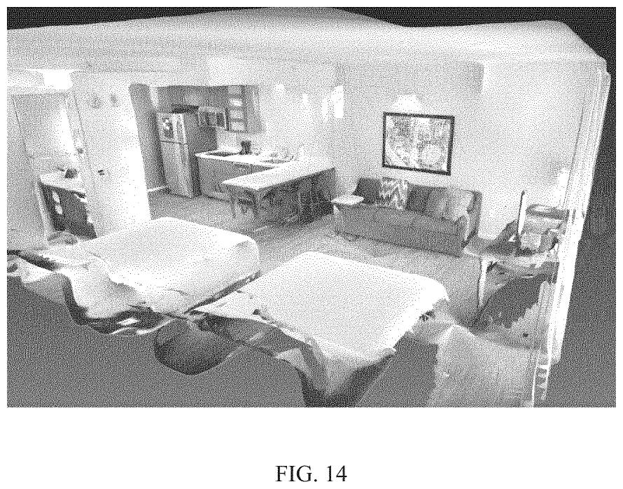

FIG. 14 illustrates a 3D model in which such an unseen face is shown. The unseen face is displayed in blue, and it can be seen that the unseen face occurs in back of a bed, below a sink, at a portion covered by a table, and the like.

The computing device 300 may perform color filling on the unseen face as illustrated in FIG. 13.

Referring to FIG. 13, the computing device 300 may set an unseen face generated by an unphotographed area (S1301). The computing device 300 may set a face without the color image mapped to the face as the unseen face.

The computing device 300 checks color values of each of the plurality of vertices associated with the unseen face (S1302).

In an example where each face is a triangle having three vertices, the computing device 300 may check color values of three vertices constituting the unseen face. For example, the color value of the vertex may be determined as a pixel value of a color image corresponding to a pixel of a depth image constituting the vertex. That is, the computing device 300 may select a depth image used to derive location information to determine which vertex, and may select a color image constituting the same data set as the corresponding depth image. The computing device 300 may select a vertex-related depth pixel corresponding to a vertex from the corresponding depth image, and may select, from the color image, any vertex-related color pixel corresponding to the vertex-related depth pixel selected from the depth image. The computing device 300 may set the color value of the vertex-related color pixel as the color value of the corresponding vertex.

The computing device 300 may fill the unseen face based on the color values of each of the plurality of vertices. For example, the computing device 300 may set each vertex as a starting point, and may set the color value of the unseen face by a gradient with the color value of an adjacent vertex based on the color value of each vertex (S1303). Here, the gradient refers to a technique for changing a color set by color gradation, and various methods are applicable to the gradation technique.

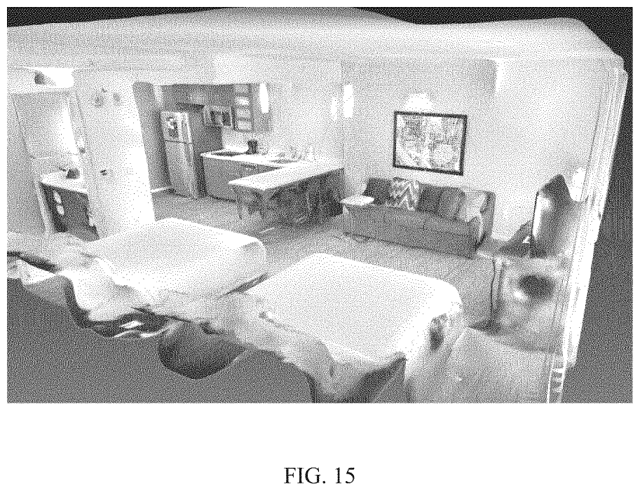

FIG. 15 illustrates an example in which the unseen face of the example of FIG. 14 is filled, and it can be seen that the unseen face is filled based on the color gradation in the illustrated example. The texturing of the unseen face by such gradation itself causes a somewhat unnatural feeling with the surrounding colors, but may be compensated more naturally by the color correction process described below.

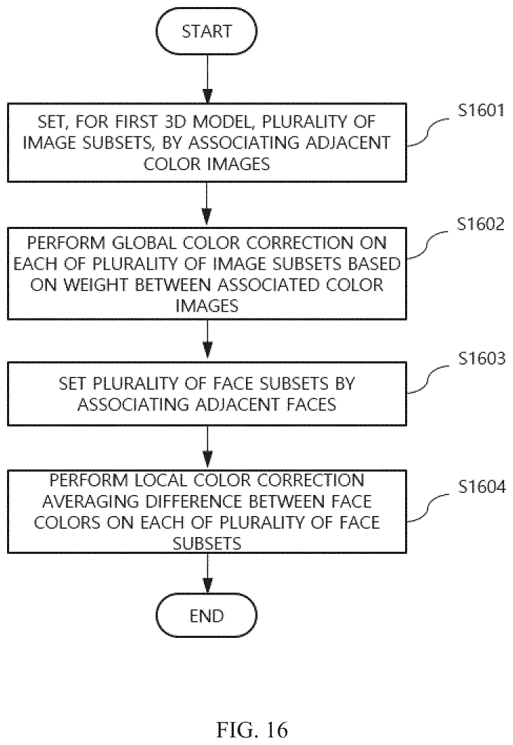

FIG. 16 is a flowchart for describing a color correction method of generating a 3D virtual model according to an embodiment disclosed in the present disclosure.

As described above, different colors may be displayed on the same surface due to different photographing environments between photographing points in a room. In particular, when several faces are adjacent to each other to form one continuous or curved surface, a difference in color values of each face gives an unnatural feeling.

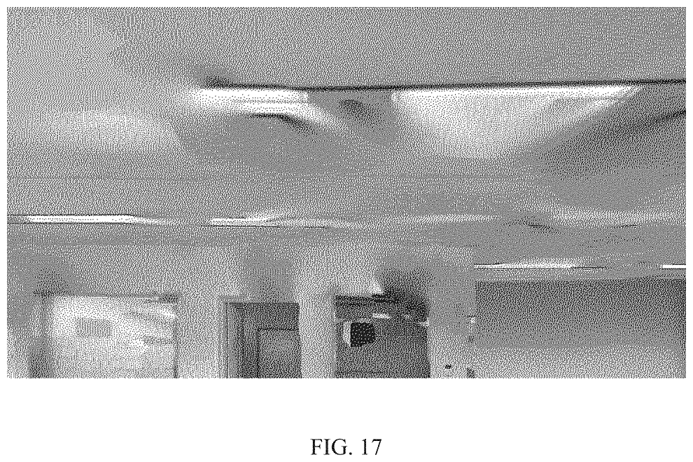

FIG. 17 illustrates a part of the 3D model before the color correction is performed, and it can be seen that in the example of FIG. 17, significant color stains occur on the same wall surface. The computing device 300 provides processing for compensating the color distortion, that is, color distortion caused by a difference in photographing environments between photographing points in a room, which will be described with reference to FIG. 16.

Referring to FIG. 16, the computing device 300 may perform correction between color images and correction between adjacent faces on the first 3D model on which texturing has been completed.

The computing device 300 may set an image subset by associating color images photographed at adjacent photographing points (S1601). A plurality of color image subsets may be set. The computing device 300 may perform global color correction on each color image subset based on a correction weight between color images associated with the corresponding color image subset (S1602). This global color correction is performed on the entire image.

As an example, the computing device 300 may determine a main color for color images associated with the color image subset. In the example of FIG. 17, a main color may be gray, and a main color weight may be set for gray which is the main color for the color images associated with FIG. 17. The main color weight may be set from a difference for an average value of the main color of the associated color images. As the main color is a color image that greatly deviates from the average value, the correction weight is set to be larger, and the color correction may be performed on each color image based on the correction weight. When the global color correction is performed as described above, since the color image itself has been corrected, the texturing may be performed again based on the corrected image.

Thereafter, the computing device 300 may perform local color correction based on the difference between the faces.

The computing device 300 may set a plurality of face subsets by associating adjacent faces (S1603).

The computing device 300 may perform local color correction on each of the face subsets by setting color differences between faces constituting the face subsets to be level (S1604). Since various methods are applicable to the leveling of the color difference, it is not limited to a specific method herein.

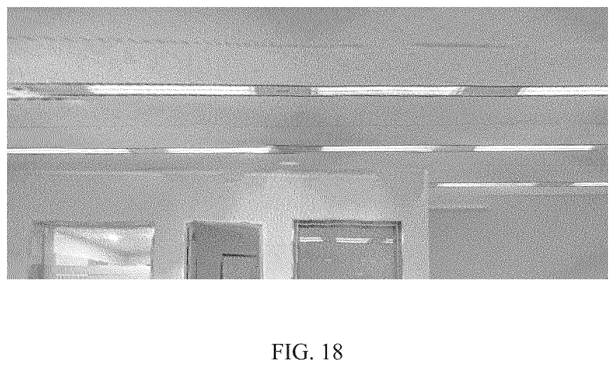

FIG. 18 illustrates an example in which the global color correction and the local color correction are applied to the example of FIG. 17. It can be seen from FIG. 17 that a portion having a large color difference was corrected to a fairly similar color.

When there are several colors on the same surface or curved surface, real users feel it is quite unnatural, so color correction plays a large role in providing realistic images for the actual 3D model.

In the present disclosure, such color correction is used in combination with global correction and local correction. In the present invention where the photographing points are considerably spaced apart from each other and the difference in the photographing conditions is large, the 3D model may be expressed more naturally through this combinatorial color correction.

Meanwhile, the control method performed by the computing device 300 according to the above-described embodiment may be implemented as a program and provided to the computing device 300. For example, a program including the control method of the computing device 300 may be provided by being stored in a non-transitory computer readable medium.

In the above description, the control method of the computing device 300 and the computer-readable recording medium including the program for executing the control method of the computing device 300 have been briefly described, but this is only for omitting redundant description, and of course, it is also applicable to the computer-readable recording medium including the control method of the computing device 300 and the program for executing the control method of the computing device 300.

Meanwhile, the machine-readable storage medium may be provided in a form of a non-transitory storage medium. Here, the ‘non-transitory storage medium’ means that the storage medium is a tangible device, and does not include a signal (for example, electromagnetic waves), and the term does not distinguish between the case where data is stored semi-permanently on a storage medium and the case where data is temporarily stored thereon. For example, the ‘non-transitory storage medium’ may include a buffer in which data is temporarily stored.

In one or more examples, by effectively selecting an image suitable for a face of a 3D model, it is possible to provide more accurate texturing even in a three-dimensional (3D) generation environment based on images photographed from several points spaced apart from each other in an indoor space.

In one or more examples, by accurately compensating color imbalance caused by different photographing conditions between several points in a room, it is possible to minimize a sense of difference for each surface of a virtual indoor space and provide a texture of a virtual space more similar to a real space.

While this disclosure includes specific examples, it will be apparent to one of ordinary skill in the art, after an understanding of the disclosure of this application, that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A texturing method of generating a three-dimensional (3D) virtual model that is performed in a computing device that generates a 3D virtual model based on a plurality of data sets each generated at one of a plurality of photographing points in an indoor space, the data set including a color image, a depth image, and location information on each point, the texturing method comprising:
generating a 3D mesh model based on the plurality of data sets each generated at one of the plurality of photographing points in the indoor space;
selecting a first face from a plurality of faces included in the 3D mesh model, and selecting any one first color image suitable for the first face from a plurality of color images associated with the first face;
performing texturing by selecting a local area corresponding to the first face from any one selected first color image and mapping the selected local area to the first face; and
generating a first 3D model by performing a color image selection process and a texturing process on the remaining faces except for the first face among the plurality of faces included in the 3D mesh model.

2. The texturing method of claim 1, further comprising generating a second 3D model by performing color adjustment on the 3D model to compensate for a color difference induced between the plurality of photographing points during photographing.

3. The texturing method of claim 1, wherein the first color image is selected from the plurality of color images associated with the 3D mesh model after evaluated based on a photographing direction, resolution, and color noise of the first face.

4. The texturing method of claim 1, wherein the selecting of any one first color image suitable for the first face from the plurality of color images associated with the 3D mesh model includes:
setting a first direction vector perpendicular to the first face;
calculating, for the plurality of color images associated with the first face, first weighting factors each having a directional correlation with a first direction vector;
calculating, for the plurality of color images associated with the first face, each second weighting factor for resolution;
calculating, for the plurality of color images associated with the first face, each third weighting factor for color noise;
calculating weights for each of the plurality of color images associated with the first face by reflecting the first to third weighting factors; and
determining any one color image having a highest weight to be the first color image.

5. The texturing method of claim 1, wherein the selecting of any one first color image suitable for the first face from the plurality of color images associated with the 3D mesh model includes:
setting a first direction vector perpendicular to the first face;
calculating, for the plurality of color images associated with the first face, first weighting factors each having a directional correlation with a first direction vector;
calculating, for the plurality of color images associated with the first face, each second weighting factor for color noise;
calculating weights for each of the plurality of color images associated with the first face by reflecting the first and second weighting factors; and
determining any one color image having a highest weight to be the first color image.

6. The texturing method of claim 1, wherein the selecting of any one first color image suitable for the first face from the plurality of color images associated with the 3D mesh model includes:
setting a first direction vector perpendicular to the first face;
calculating, for the plurality of color images associated with the first face, first weighting factors each having a directional correlation with a first direction vector;
calculating, for the plurality of color images associated with the first face, each second weighting factor for resolution;
calculating weights for each of the plurality of color images associated with the first face by reflecting the first and second weighting factors; and
determining any one color image having a highest weight to be the first color image.

7. The texturing method of claim 1, wherein the selecting of the first face from the plurality of faces included in the 3D mesh model, and selecting any one first color image suitable for the first face from the plurality of color images associated with the first face includes:
setting an unseen face generated by an unphotographed area;
checking color values of each of a plurality of vertices associated with the unseen face; and
filling the unseen face based on the color values of each of the plurality of vertices.

8. The texturing method of claim 7, wherein the filling of the unseen face based on the color values of each of the plurality of vertices includes:
setting each vertex as a starting point; and
setting a color value of the unseen face by a gradient with a color value of an adjacent vertex based on the color values of each vertex.

9. A computing device comprising:
a memory configured to store one or more instructions; and
at least one processor configured to execute the one or more instructions stored in the memory,
wherein the at least one processor executes the one or more instructions to:
generate a three-dimensional (3D) mesh model based on a plurality of data sets each generated at one of a plurality of photographing points in an indoor space, the data set including a color image, a depth image, and location information on each point;
select a first face from a plurality of faces included in the 3D mesh model, and select any one first color image suitable for the first face from a plurality of color images associated with the first face;
perform texturing by selecting a local area corresponding to the first face from any one selected first color image and mapping the selected local area to the first face; and
generate a first 3D model by performing a color image selection process and a texturing process on the remaining faces except for the first face among the plurality of faces included in the 3D mesh model.

10. The computing device of claim 9, wherein the at least one processor generates a second 3D model by performing color adjustment on the 3D model to compensate for a color difference induced between the plurality of photographing points during photographing.

11. The computing device of claim 9, wherein the first color image is selected from the plurality of color images associated with the 3D mesh model after evaluated based on a photographing direction, resolution, and color noise of the first face.

12. The computing device of claim 9, wherein the at least one processor sets a first direction vector perpendicular to the first face,
calculates, for the plurality of color images associated with the first face, first weighting factors each having a directional correlation with a first direction vector,
calculates, for the plurality of color images associated with the first face, each second weighting factor for resolution,
calculates, for the plurality of color images associated with the first face, each third weighting factor for color noise,
calculates weights for each of the plurality of color images associated with the first face by reflecting the first to third weighting factors, and
determines any one color image having a highest weight to be the first color image.

13. The computing device of claim 9, wherein the at least one processor sets an unseen face caused by an unphotographed area,
checks color values of each of a plurality of vertices associated with the unseen face, and
fills the unseen face based on the color values of each of the plurality of vertices.

14. The computing device of claim 13, wherein the at least one processor sets each vertex as a starting point, and sets a color value of the unseen face by a gradient with a color value of an adjacent vertex based on the color values of each vertex.

15. A non-transitory computer-readable storage medium storing instructions that, when executed by a processor, cause the processor to execute the operations of:
generating a three-dimensional (3D) mesh model based on a plurality of data sets each generated at one of a plurality of photographing points in an indoor space, the data set including a color image, a depth image, and location information on each point,
selecting a first face from a plurality of faces included in the 3D mesh model, and selecting any one first color image suitable for the first face from a plurality of color images associated with the first face;
performing texturing by selecting a local area corresponding to the first face from any one selected first color image and mapping the selected local area to the first face; and
generating a first 3D model by performing a color image selection process and a texturing process on the remaining faces except for the first face among the plurality of faces included in the 3D mesh model.
